(19) United States
(12) Patent Application Publication
(10) Pub. No.: US 2007/0085413 A1
(43) Pub. Date: Apr. 19, 2007

(54) Spoke assembling structure for a bicycle wheel

(76) Inventor: Yen-Jiun Lin, Huatan Township (TW)

Correspondence Address: CHARLES E. BAXLEY, ESQ., 90 JOHN STREET, THIRD FLOOR, NEW YORK, NY, 10038, US

(21) Appl. No.: 11/253,952

(22) Filed: Oct. 18, 2005

(51) Int. Cl. B60B 1/02

(52) U.S. Cl. 301/55

(57) ABSTRACT

A spoke-assembling structure for a bicycle wheel comprises a hub, a plurality of sets of spokes and a wheel. In the wheel being formed a plurality of apertures for anchoring an end of the spokes. The spokes are connected between the wheel and the hub. In the wheel are additionally formed a plurality of assistant apertures for anchoring a plurality of assistant spokes, both end of the assistant spokes are directly anchored on a rim of the wheel, vertical distances from the respective assistant spokes to the hub are the same.

### BACKGROUND OF THE INVENTION

1. Field of the Invention

The present invention relates to a product of bicycle, and more particularly to a spoke assembling structure for a bicycle wheel.

2. Description of the Prior Art

Conventional spoke assembling structures generally includes two types. A first type spoke assembling structure as shown in FIGS. 1 and 2 generally comprises plural sets of spokes 21 connected between the rim 30 of a wheel and the hub flange 11 of a hub 10. Each set of spokes 21 include two spokes 21 that cross each other and are anchored in the apertures 31 of the rim 30. The rim 30 can be trued by rotating the nipples 40 of the spokes 21. TW Serial No. 092211794 and 091216485 are of the first type spoke assembling structure. A second type spoke assembling structure is shown in FIG. 3, wherein each set of spokes comprises three spokes 21, and TW Serial No. 093205755 and 090209402 are of this type.

The disadvantages of the conventional spoke assembling structures are explained as follows:

Firstly, the spokes have to burden a great weight since the bicycle' weight and the rider's weight are all loaded on the spokes, in this case, the only way of increasing the loading capacity of the bicycle is to increase the number of the spokes. However, as shown in FIG. 2, each pair of spokes cross each other to form a V-shaped configuration, and increasing the number of spokes means increasing the density of the V-shaped arrangements of the spokes. Therefore, the drag coefficient of the bicycle will be increased.

Secondly, if the spokes are not adjusted appropriately, the wheel is liable to distortion and will wobble around its hub after a certain time of use.

The present invention has arisen to mitigate and/or obviate the afore-described disadvantages.

### SUMMARY OF THE INVENTION

The primary objective of the present invention is to provide a spoke-assembling structure for a bicycle wheel, wherein both ends of the assistant spokes are directly anchored on the rim of the wheel and are arranged in a parallel manner in pairs around the hub. Such arrangements not only can improve the structural strength of the bicycle wheel, but also can reduce the drag coefficient of the wheel because the number of the spokes is relatively decreased.

The secondary objective of the present invention is to provide a spoke-assembling structure for a bicycle wheel, wherein both ends of the assistant spokes are directly anchored on the rim of the wheel, so that the user only needs to rotate the nipple at any end of the assistant spokes when truing the wheel.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of showing a conventional spoke-assembling structure for a bicycle wheel;

FIG. 2 is a cross sectional view of the conventional spoke-assembling structure for a bicycle wheel;

FIG. 3 is a perspective view of showing another conventional spoke-assembling structure for a bicycle wheel;

FIG. 4 is an assembly view of a spoke-assembling structure for a bicycle wheel in accordance with a first embodiment of the present invention;

FIG. 4a is an enlarged view of a part of FIG. 4;

FIG. 5 is a side view of the spoke-assembling structure for a bicycle wheel in accordance with a first embodiment of the present invention;

FIG. 5a is an enlarged view of FIG. 5; and

FIG. 6 is a side view of a spoke-assembling structure for a bicycle wheel in accordance with a second embodiment of the present invention.

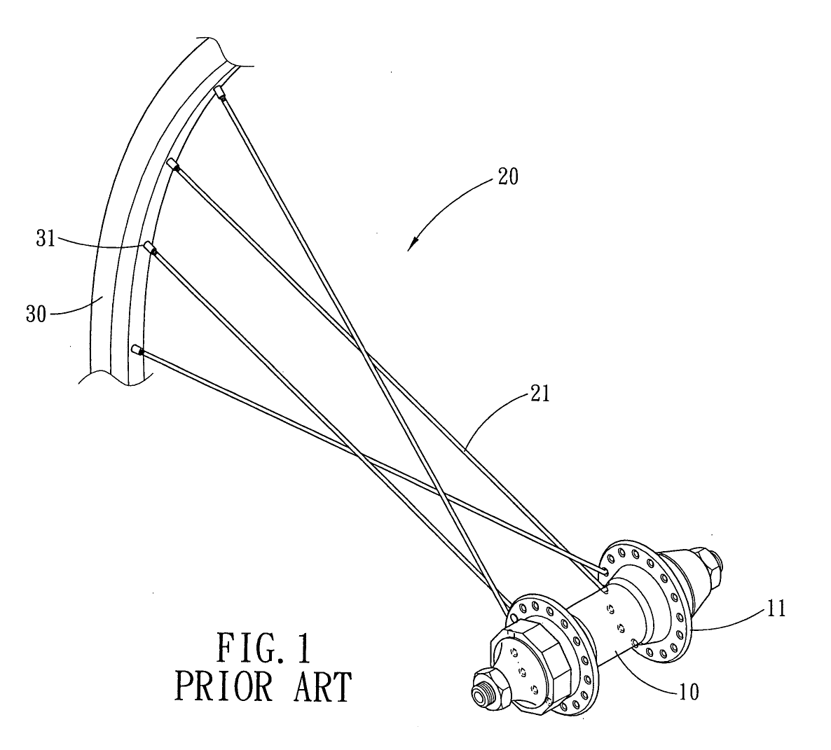

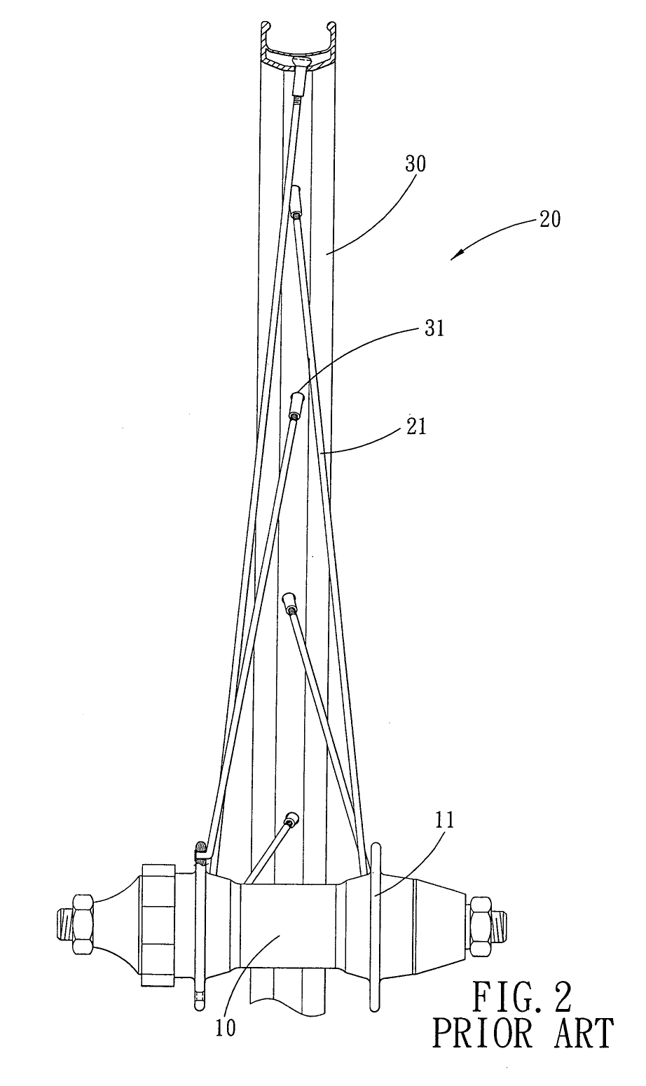

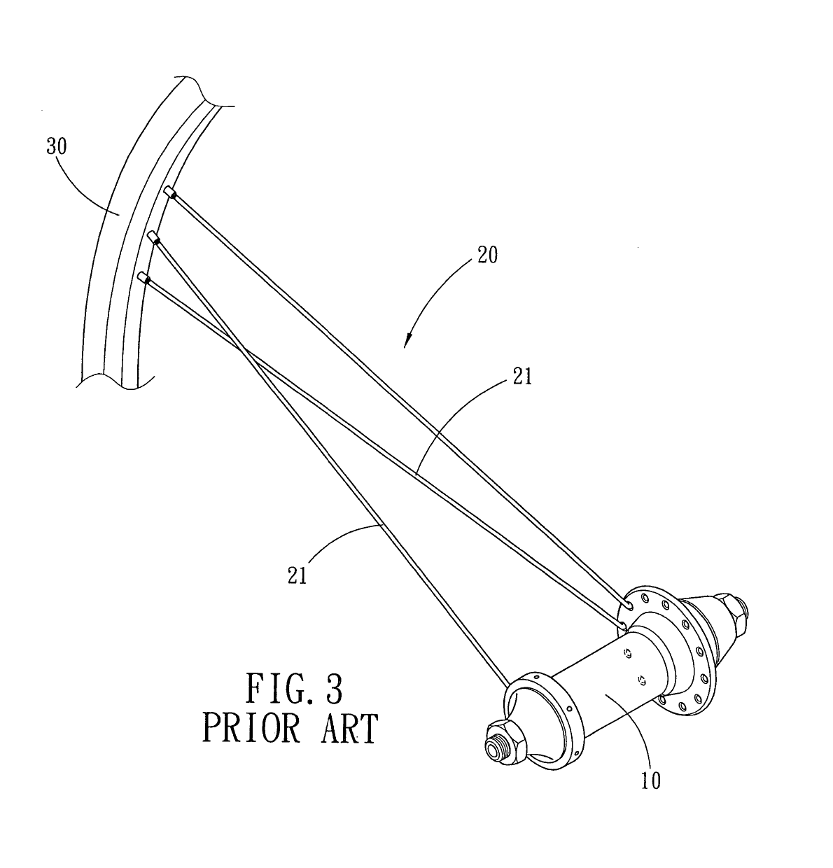

### DETAILED DESCRIPTION OF THE PREFERRED EMBODIMENTS

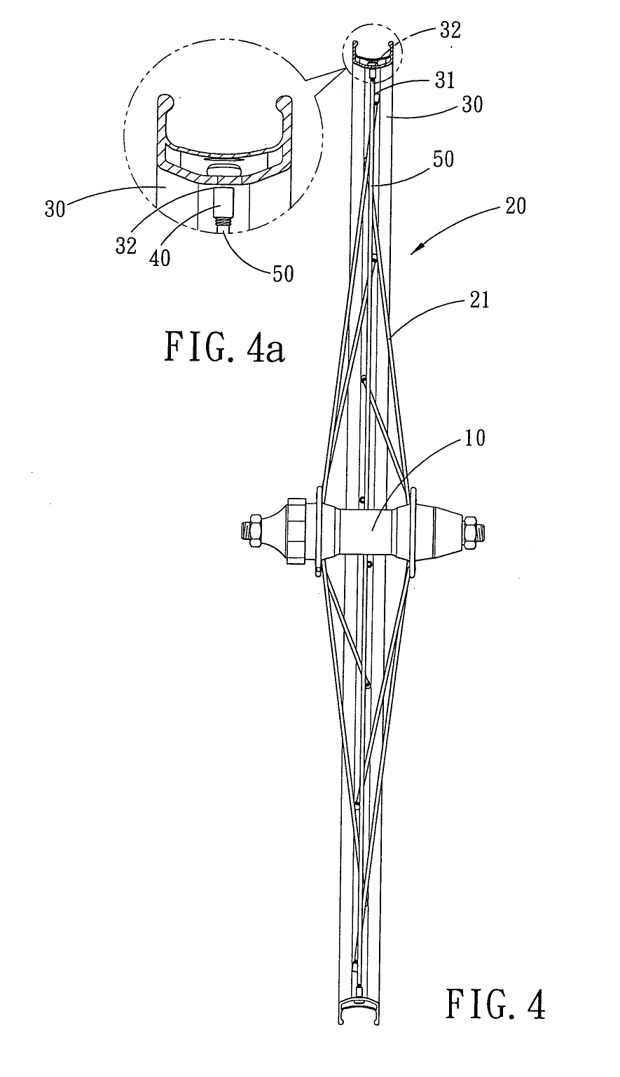

Referring to FIG. 4, a spoke-assembling structure in accordance with a first embodiment of the present invention is shown and comprises a hub 10, a plurality of sets of spokes 20 and a wheel 30. In the wheel 30 are formed a plurality of apertures 31 for anchoring an end of the spokes 21. The spokes 21 are connected between the wheel 30 and the hub 10.

In the wheel 30 are additionally formed a plurality of assistant apertures 32 for anchoring a plurality of assistant spokes 50, and both end of the assistant spokes 50 are anchored on the rim of the wheel 30. The vertical distances from the respective assistant spokes 50 to the hub 10 are the same. At each end of the assistant spokes is arranged a nipple. The arrangement of the assistant apertures 32 and the assistant spokes 50 can be varied according to need.

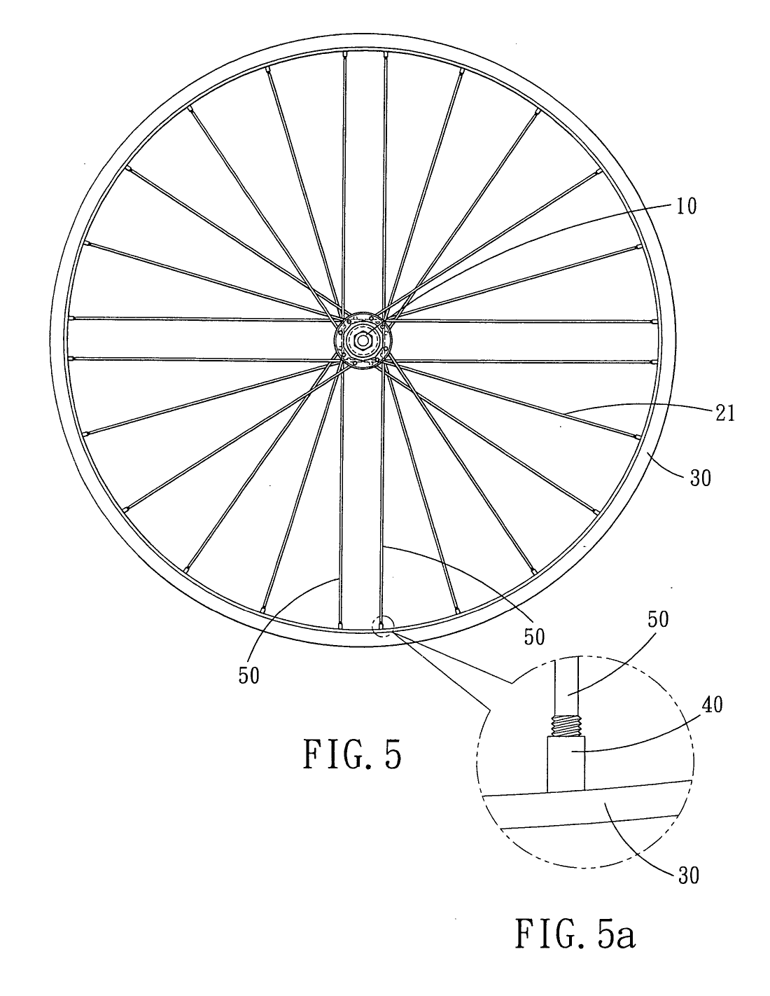

For a better understanding of the present invention, its operation and function, reference should be made to FIGS. 4 and 5. In consideration of decreasing the drag coefficient, each set of spokes preferably includes 2 spokes, and the assistant spokes 50 are directly anchored on the rim of the wheel 30 and arranged in a parallel manner in pairs around the hub 10. Such arrangements not only can improve the structural strength of the bicycle wheel, but also can reduce the drag coefficient of the wheel because the number of the spokes 21 is relatively decreased.

It will be noted that the vertical distances from the respective assistant spokes 50 to the hub 10 are the same, and viewing from a side of the wheel 30, the assistant spokes 50 are arranged in a random crisscross manner.

On the other hand, at an end of the assistant spokes 50 is mounted a nipple 40 that can be rotated to true the wheel 30. The conventional V-shaped arrangement of the spokes will not only increase the number of the spokes 21, increasing the drag coefficient, but also the user has to rotate more nipples 40 when truing the wheel. The present invention makes the wheel-truing job much easier, since both ends of the assistant spokes 50 are anchored on the wheel 30 directly, and the user only needs to rotate the nipple 40 at any end of the assistant spokes 50 when truing the wheel. Furthermore, the assistant spokes 50 are anchored in pairs on the wheel 30, this makes the wheel 30 maintain a high roundness.

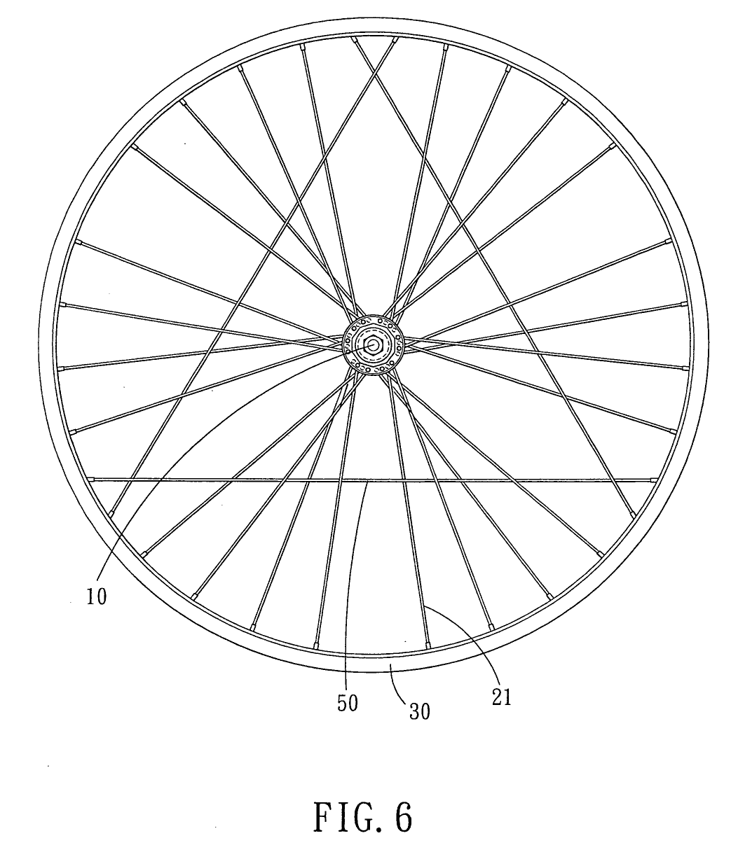

Referring then to FIG. 6, a spoke-assembling structure in accordance with a second embodiment of the present invention is shown, and the different of this embodiment as compared with the first embodiment is that, viewing from a side of the wheel 30, the assistant spokes 50 are arranged in a triangle or polygonal shape (such as pentagon, hexagon).

While we have shown and described various embodiments in accordance with the present invention, it should be clear to those skilled in the art that further embodiments may be made without departing from the scope of the present invention.

What is claimed is:

1. A spoke-assembling structure for a bicycle wheel comprising a hub, a plurality of sets of spokes and a wheel, in the wheel being formed a plurality of apertures for anchoring an end of the spokes, the spokes are connected between the wheel and the hub;
in the wheel are additionally formed a plurality of assistant apertures for anchoring a plurality of assistant spokes, both end of the assistant spokes are directly anchored on a rim of the wheel, vertical distances from the respective assistant spokes to the hub are the same.

2. The spoke-assembling structure for a bicycle wheel as claimed in claim 1, wherein the assistant spokes are arranged in a random crisscross manner, viewing from a side of the wheel.

3. The spoke-assembling structure for a bicycle wheel as claimed in claim 1, wherein the assistant spokes are arranged in a triangle, viewing from a side of the wheel.

4. The spoke-assembling structure for a bicycle wheel as claimed in claim 1, wherein each end of the assistant spokes are arranged with a nipple.
